(19) United States
(12) Patent Application Publication
(10) Pub. No.: US 2007/0089789 A1
(43) Pub. Date: Apr. 26, 2007

(54) Higher accuracy pressure based flow controller

(76) Inventors: Daniel T. Mudd, Reno, NV (US); William W. White, Sparks, NV (US)

Correspondence Address: STEPTOE & JOHNSON LLP, 1330 CONNECTICUT AVENUE, NW, WASHINGTON, DC, 20036, US

(21) Appl. No.: 11/549,084

(22) Filed: Oct. 12, 2006

Related U.S. Application Data
(63) Continuation of application No. 10/652,506, filed on Aug. 28, 2003, now abandoned.
(60) Provisional application No. 60/406,511, filed on Aug. 28, 2002.

(51) Int. Cl. G05D 7/06

(52) U.S. Cl. 137/487.5

(57) ABSTRACT

A mass flow controller is disclosed and includes body portion having a first internal passage and at least second internal passage formed therein, a flow control valve coupled to the body portion and in communication with the first and second internal passages, at least one pressure transducer coupled to the body portion and in communication with at least one of the first internal passage, the second internal passage, and the flow restrictor, a nonlinear flow restrictor configured to produce a high compressible laminar flow therethrough coupled to the second internal passage, a thermal sensor in communication with at least one of the first internal passage, the second internal passage, and the flow restrictor, and an exhaust vessel in communication with the flow restrictor.

### CROSS REFERENCE TO RELATED APPLICATIONS

The present application claims priority to U.S. Non-Provisional patent application Ser. No. 10/652,506, filed Aug. 28, 2003 and to U.S. Provisional Patent Application Ser. No. 60/406,511, filed Aug. 28, 2002, the contents of which is hereby incorporated by reference in its entirety herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

A variety of manufacturing processes require the control over the rate and flow of fluids. For example, the semiconductor fabrication processes may require the discharge of very precise quantities of fluids (primarily gases) into a process chamber. Flow rates ranging from as high as twenty liters per minute to as low as a few tenths of one cubic centimeter per minute (CCM) may be required during the fabrication process.

In response, mass flow controllers have been developed which measure and control the flow rate of fluids wherein the flow rate measurements are based on thermal properties of the fluids. Typically, these thermal mass flow controllers are used to monitor and control the flow of fluids such as toxic and highly reactive gases, of the type used in the fabrication of semiconductor devices. Furthermore, in a variety of manufacturing procedures, various gases are used in etching and vapor deposition processes. These gases may be toxic to humans and may be highly reactive when exposed to ambient atmospheric conditions.

In addition, a number of fluid mass flow controllers have been developed which operate by measuring a pressure drop across a flow restrictor or orifice. While these devices have proven useful in measuring and controlling the mass flow, a number of shortcomings have been identified. For example, prior art mass flow controllers accurately control the flow rate over limited flow range, but may introduce control errors when controlling the flow rate of a fluid over a wider dynamic range.

Accordingly, several desiderata have been identified for pressure sensors and fluid mass flow controllers incorporating such pressure sensors, particularly of the type used in manufacturing processes as described above. Such desiderata include: controller accuracy within a few percent of controller setpoint (currently at 1 percent of full scale are obtainable with present devices) (less than one percent is desired); operation at elevated or below “normal” temperatures and various positions or attitudes (i.e., right side up, sideways, or upside down), without loss of accuracy, such as experienced by thermal based mass flow controllers; accurate measurement and control over a wide range of flow rates; fast response time from turn-on to achieving stable flow conditions; economy of manufacture; and uncomplicated modular mechanical structure to facilitate servicing the flow controller and to facilitate changing the flow controller out of the fluid flow distribution system for the manufacturing process. Other features desired in fluid mass flow controllers include no requirement to calibrate each complete controller instrument at the time of manufacture or recalibrate the instrument after servicing, the provision of a reliable easily interchanged flow restrictor or orifice part, ease of verification of the operability and accuracy of the flow controller after servicing or change out of a flow restrictor, the ability to accurately control flow rates for a wide variety of toxic and/or reactive fluids, particularly the hundreds of fluids in gaseous form which are used in semiconductor fabrication processes, and ease of changing the controller working data for flow rates for different gases or fluids in liquid form.

### SUMMARY

The present application is directed to pressure based flow controllers. More specifically, the present application discloses various pressure based flow controller having higher accuracy over a wider dynamic range than present flow control devices.

In one embodiment, a mass flow controller is disclosed and includes body portion having a first internal passage and at least second internal passage formed therein, a flow control valve coupled to the body portion and in communication with the first and second internal passages, at least one pressure transducer coupled to the body portion and in communication with at least one of the first internal passage, the second internal passage, and the flow restrictor, a nonlinear flow restrictor configured to produce a high compressible laminar flow therethrough coupled to the second internal passage, a thermal sensor in communication with at least one of the first internal passage, the second internal passage, and the flow restrictor, and an exhaust vessel in communication with the flow restrictor.

In another embodiment a mass flow controller is disclosed and includes one or more pressure sensors, an upstream valve, a nonlinear restrictor positioned downstream of the valve and the pressure sensor and configured to have a more incremental flow pressure at an inlet of the restrictor at low flows.

### BRIEF DESCRIPTION OF THE DRAWINGS

FIG. 1 is an isometric view of a fluid mass flow controller;

FIG. 2 is an illustration of three different flow zones in one embodiment of the mass flow controller of FIG. 1 when exhausting to vacuum;

FIG. 3 is a graph illustrating flow characteristics where the mass flow controller of FIG. 1 is exhausting to vacuum;

FIG. 4 is a graph illustrating changes in flow sensitivity of the mass flow controller of FIG. 1 as a function of flow rate;

FIG. 5 is a graph illustrating anticipated flow measurement errors in the mass flow controller of FIG. 1 based on anticipated transducer calibration drift as illustrated in FIG. 6;

FIG. 6 is a graph illustrating transducer stability in the mass flow controller of FIG. 1 with respect to reference pressures;

FIG. 7A is a graph illustrating a stability level of the mass flow controller of FIG. 1 at a flow rate of about 172.0 sccm and illustrates the influence of temperature thereon;

FIG. 7B is a graph illustrating a stability level of the mass flow controller of FIG. 1 at a flow rate of about 46.0 sccm and illustrates the influence of temperature thereon;

FIG. 7C is a graph illustrating a stability level of the mass flow controller of FIG. 1 at a flow rate of about 10.75 sccm and illustrates the influence of temperature thereon; and

FIG. 7D is a graph illustrating an actual temperature reading and an erroneous temperature reading of fluid flowing through the mass flow controller of FIG. 1.

### DETAILED DESCRIPTION OF THE INVENTION

The present disclosure relates to flow controllers, and more particularly, a higher accuracy pressure based flow controllers. It is understood, however, that the following disclosure provides many different embodiments, or examples, for implementing different features of the flow controller. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

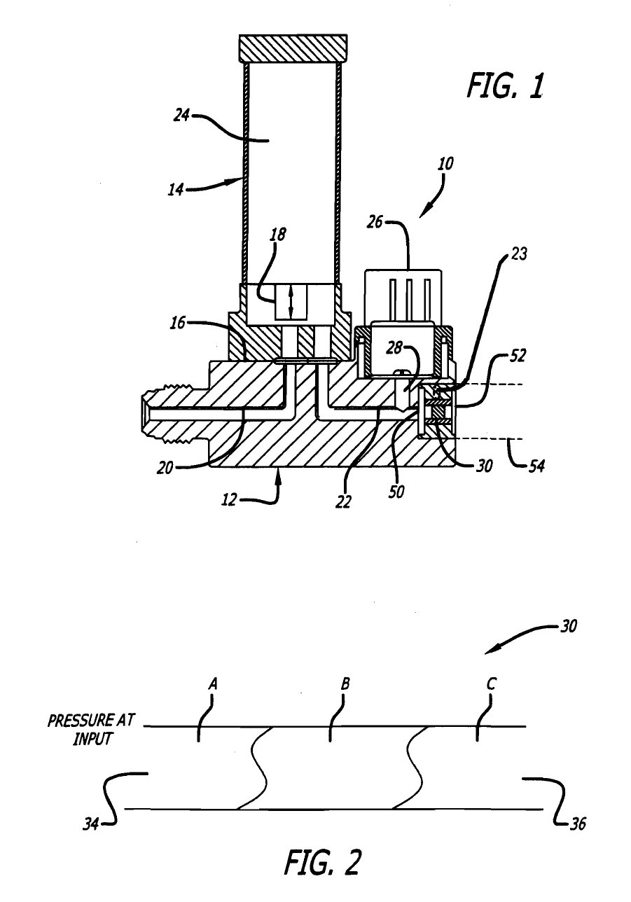

Referring to FIG. 1, an exemplary mass flow controller (MFC) 10 is illustrated. Various embodiments of the flow controller 10 are presented and more fully described in U.S. Provisional Patent Application Ser. No. 60/329,031, filed on Oct. 12, 2001, and U.S. patent application Ser. No. 09/666,039, filed on Sep. 20, 2000, both of which are hereby incorporated by reference as if reproduced in their entirety.

The MFC 10 of the present embodiment is illustrated with a single body portion 12. It is understood that one or more modular body parts (not shown) may be added to the body portion 12 as desired. The body portion 12 may be provided with suitable connectors (not shown) for connection with conduits of a fluid supply system, such as a semiconductor fabrication system for supplying, in particular, toxic or reactive fluids in gaseous form for use in semiconductor fabrication, for example.

The MFC 10 supports an electrically controlled flow control valve 14 which is removably mounted on a face 16 of the body portion 12 by conventional mechanical fasteners (not shown). Exemplary mechanical fasteners include, without limitation, screw fits, screws, pins, lock members, snap fits, and lock members. The flow control valve 14 is preferably of preassembled, modular construction so that it can be readily mounted on the body portion 12 at a predetermined position so that no adjustment of the flow control valve 14 is needed once mounted. This is advantageous over prior art systems where the valve 14 is not modular, and therefore must be adjusted, which typically requires a relatively large amount of time. The valve 14 includes an electrically actuated closure member 18 operable to throttle the flow of fluid from a first internal passage 20 to a second internal passage 22. The first internal passage 20 is in fluid communication with a source pressure vessel. The valve 14 also includes an actuator 24 for moving the closure member 18 between a fully open and fully closed position. The actuator 24 is preferably of the solenoid or piezoelectric type for rapidly and precisely controlling the position of the closure member 18 between the fully open and closed positions with a high degree of resolution. Some embodiments may not utilize the valve 14 and so would serve as flow meters rather than flow controllers.

A pressure transducer 26 is mounted on the face 16 of the body portion 12 and is in fluid communication with the second internal passage 22 formed in the body portion 12. In the illustrated embodiment, the pressure transducer 26 communicates with the second internal passage 22 through a third internal passage 28. In an alternate embodiment, the pressure transducer may be coupled to the second internal passage 22 and configured to measure the pressure a fluid flowing therethrough, thereby eliminating the need for a third internal passage 28. Those skilled in the art will appreciate that by coupling the pressure transducer 26 directly to the second internal passage 22 the “dead space” within the MFC 10 may be minimized. Most pressure transducers, such as the transducer 26 of FIG. 1, exhibit zero drift and span drift. Zero drift describes a change that occurs in a measurement when there is zero input. Span drift describes a change in an upper or lower limit of a range. Zero drift is typically the larger component and may comprise up to 80% of the total drift.

As shown in FIG. 1, at least one thermal sensor 23 may be positioned on or otherwise in communication with the body portion 12. The at least one thermal sensor 23 is configured to measure the temperature of a fluid traversing the first internal passage 20, the second internal passage 22, the flow restrictor 30, or any of the above. In one embodiment, the thermal sensor is coupled to at least one of the first internal passage 20, the second internal passage 22, the flow restrictor 30, or any of the above. In an alternate embodiment, the thermal sensor 23 includes a sensing device (not shown) positioned within the first internal passage 20, the second internal passage 22, the flow restrictor 30, or any of the above. Exemplary thermal sensors 23 include, for example, thermometers, thermamcouples, infrared sensors, or other temperature reading devices known in the art.

In an alternate embodiment, at least one thermal control element (not shown) may be in communication with the body portion 12 of the MFC 10. The at least one thermal control element (not shown) may be in coupled to at least one of first internal passage 20, the second internal passage 22, the flow restrictor 30, or any of the above, and may be configured to regulate the temperature of the internal passages 20, 22, the flow restrictor 30, at a desired temperature. For example, in one embodiment, the thermal control element (not shown) may be configured to heat the flow restrictor 30 to a desired temperature, thereby maintaining the temperature of a fluid flowing therein at a desired temperature. Exemplary thermal control elements include, without limitation, coil heaters, resistance heaters, piezoelectric heater and coolers, or other device known in the art.

Referring again to FIG. 1, a flow restrictor 30 is coupled to the second internal passage 22 downstream of the control valve 14 and includes a flow restrictor inlet 50 and a flow restrictor outlet 52. In one embodiment, the flow restrictor 30 comprises a highly non-linear flow restrictor having an elongated tubular body or capillary body. A capillary or laminar flow is created within the flow restrictor 30 due to the elongated body length of the capillary body and the relatively small hydraulic diameter thereof. A beneficial nonlinearity may be created when a highly compressible laminar flow traverses the capillary body. More specifically, the beneficial nonlinearity may be created when the flow restrictor 30 has a relatively small hydraulic diameter when compared to the flow restrictor path length (L/D) and the flow through the restrictor is a high compressible laminar flow. Those skilled in the art will appreciate that the flow restrictor 30 may be manufactured in a variety of lengths and internal diameters to produce a highly compressible laminar flow therethrough and may be fabricated from a variety of materials. For example, in one embodiment the flow restrictor 30 is manufactured from stainless steel or nickel particles suitably compressed and sintered to provide the desired porosity and flow restriction properties. It will be understood that the flow restrictor 30 can be constructed of other materials or configurations. Exemplary alternate configurations include, without limitation, coiled capillary tubes having a relatively small hydraulic diameters, flat plates, grooved plates, annular plates, orifices, parallel plates, stacked plates, coiled sheets, or other configurations known in art.

The flow restrictor outlet 52 may be coupled to a variety of vessels configured to receive the exhaust of the MFC 10 therein. For example, in one embodiment, the flow restrictor outlet 52 is coupled to an exhaust vessel having a vacuum formed therein. In an alternate embodiment, the flow restrictor outlet 52 is coupled to an outlet vessel having a near vacuum formed therein. For example, the outlet vessel may be at about 1 psia or less. Optional, the flow restrictor outlet 52 may be in communication with an exhaust vessel having a pressure drop and/or variable vacuum formed therein. For example, the outlet vessel may have a pressure which varies from about 0 psia to about 5 psia. Optionally, a second pressure transducer 54 may be positioned proximate the flow restrictor 30 and configured to measure the pressure of the exhaust exiting the MFC 10.

During use, a pressure drop between the pressure at the flow restrictor inlet 50 and the pressure at the flow restrictor outlet 52 is formed. In one embodiment, the pressure drop between the flow restrictor inlet 50 and the flow restrictor outlet 52 is at least about 50 percent of the pressure at the flow restrictor inlet 50. In another embodiment, the pressure drop between the flow restrictor inlet 50 and the flow restrictor outlet 52 is at least about 60 percent of the pressure at the flow restrictor inlet 50. In still another embodiment, the pressure drop between the flow restrictor inlet 50 and the flow restrictor outlet 52 is at least about 70 percent of the pressure at the flow restrictor inlet 50. In short, the pressure drop between the flow restrictor inlet 50 and the flow restrictor outlet 52 may be at least about 50 percent to approaching 100 percent of the pressure at the flow restrictor inlet 50.

In the present application, compressible laminar flow is defined as a pressure drop between a flow restrictor inlet 50 and a flow restrictor outlet 52 of at least about 10 percent of the pressure at the flow restrictor inlet 50, while highly compressible laminar flow is defined as a pressure drop between a flow restrictor inlet 50 and a flow restrictor outlet 52 of at least about 50 percent of the pressure at the flow restrictor inlet 50. As a result of the generation of a highly compressible laminar flow through the flow restrictor 30, a MFC 10 having a beneficial nonlinearity produces a shift to a “percent of reading error” characteristic rather than a “percent of full scale error” characteristic. As such, the MFC 10 has an enhanced dynamic range, particularly at low flow rates, than presently available.

Referring now to FIG. 2, an exemplary flow restrictor 30 is illustrated. For purposes of illustration, a pressurized fluid is passing into the flow restrictor inlet 50 and exiting into a vacuum through the flow restrictor outlet 52. Inside the flow restrictor 30, fluid flow is divided into three different zones designated A, B, and C. In zone A, the fluid flow has primarily laminar characteristics. In zone B, the fluid flow has high velocity and associated increase kinetic losses. In zone C, the fluid flow has primarily molecular characteristics. It is understood that these zones may vary according to the pressure source, restrictor parameters, and other variables. When exhausting to near vacuum zones B and C may be eliminated. As a result, the laminar characteristics of zone A may be present through substantially the entire length of the flow restrictor 30 while maintaining beneficial non-linearity.

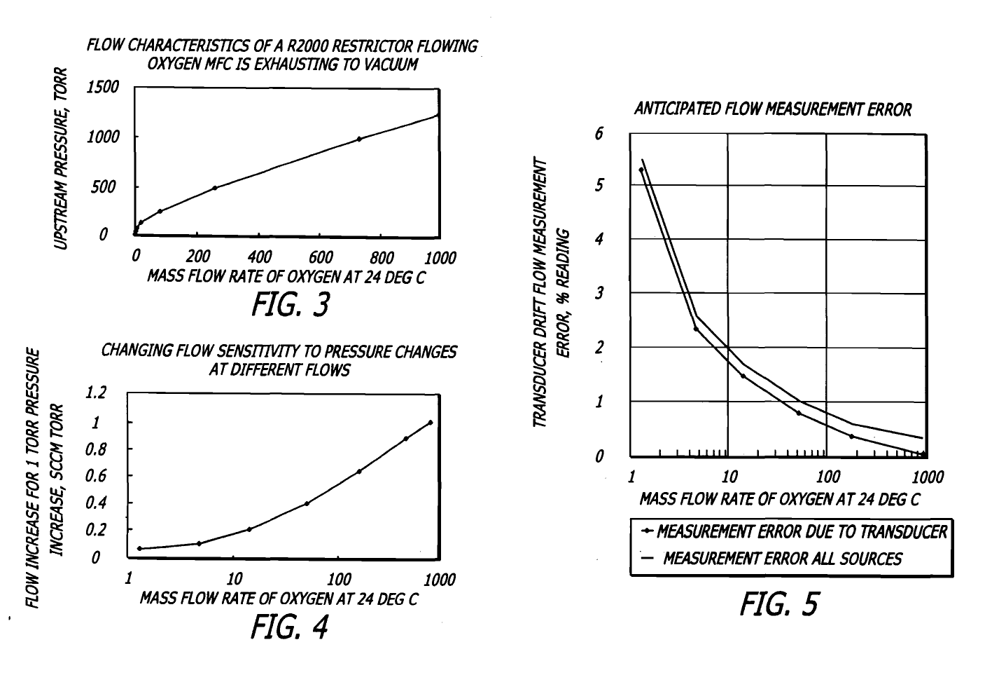

Referring now to FIGS. 3-7, for a pressure based MFC where flow is proportional to inlet pressure (sonic applications) or differential pressure (laminar flow elements (LFE's) where the pressure drop is small compared to the line pressure), a change in the zero of the pressure transducer will translate into a calibration error for the MFC that takes on a “Percent of Full Scale” characteristic.

FIG. 3 shows a graph of the flow characteristics of a non-linear flow restrictor configured to produce a highly compressible laminar flow. To produce the data illustrated on FIG. 3, an MFC having a nonlinear flow restrictor was configured to flow oxygen at a temperature of 24° C. and was exhausted to a vacuum. As shown in FIG. 3, the flow restrictor disclosed herein produces a slope of the flow vs. inlet pressure curve which is highly nonlinear and much steeper at lower flows than at higher flows. The non-linear characteristics of the flow restrictor produces a MFC which is more accuracy at lower flow rates than presently available.

FIG. 4 shows a graph of the sensitivity of a nonlinear flow restrictor to pressure measurement errors at various flow rates. As illustrated in FIG. 4, an MFC having a nonlinear flow restrictor was configured to flow oxygen at a temperature of 24° C. and was exhausted to a vacuum. As shown in FIG. 4, the pressure sensitivity to pressure measurement errors of the MFC is reduced at lower flow rates. As a result, FIGS. 3 and 4 illustrate that a MFC having a nonlinear flow restrictor as described is capable of accurately controlling the flow rate of a fluid over a wider dynamic range than nonlinear restrictors presently available.

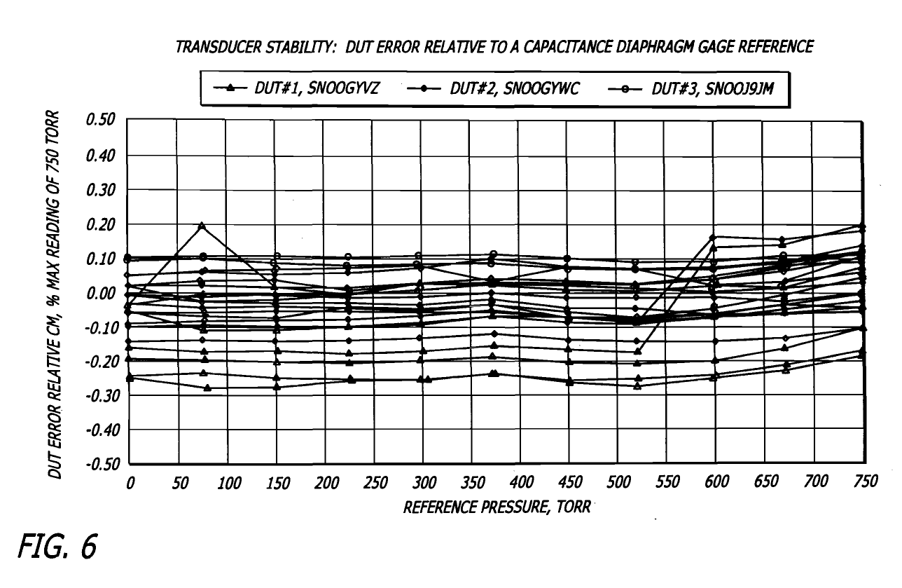

FIG. 5 shows a graph illustrating the flow rate error in “percent of reading” induced by pressure measurement error typical of the transducer of FIG. 6. As shown, a 1 Torr pressure measurement error produces a flow error of about 1 “percent of reading” or less for flows of about 20 sccm or greater, and a flow error of about 6 “percent of reading” for flows between about 1 sccm to about 20 sccm.

FIG. 6 graphically illustrates the stability of the pressure transducers of the MFC 10. As described above, zero drift describes a change that occurs in a measurement when there is zero input. span drift describes a change in an upper or lower limit of a range. Zero drift is typically the larger component and may comprise up to 80% of the total drift. When illustrated graphically, zero drift appears as a vertical deviation from a mean value. For example, line 60 of FIG. 6 represents the transponder error relative to pressure. As shown, line 60 remains fairly constant at a value of 0.10 across a range of reference pressures from about 0 Torr to about 750 Torr, and possesses a slope approaching 0.

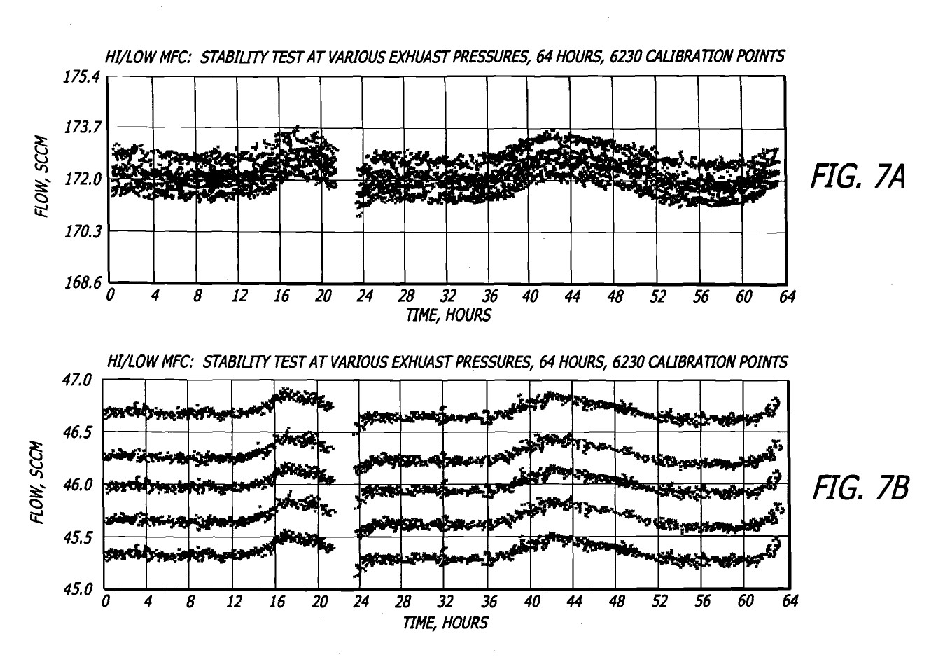

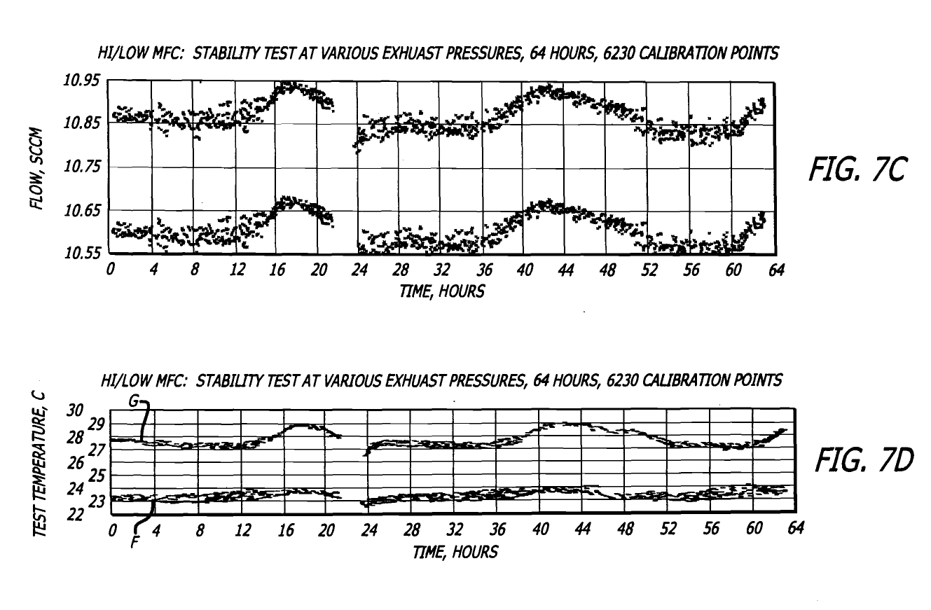

FIG. 7A-7D shows several graphical representations of the stability over time of a MFC having a nonlinear flow restrictor as described above and the effects of miscompensated temperature variations thereon. In FIGS. 7A-7C, a single 1000 sccm MFC was tested at flow rates of about 172.0 sccm, 46.0 sccm, and 10.75 sccm. FIG. 7D shows the actual temperature, see line F, of the fluid flowing through the MFCs in relation to the estimated temperature of the flow, see line G, as compensated for by a control system coupled to the MFC. As shown in the FIGS. 7A-7D, between the hours of 12 and 20 the actual temperature of the fluid flowing through the MFC varied between about 23° C. to about 24° C. The control system coupled to the MFC erroneously determined the temperature of the fluid flowing through the MFC to vary between about 27° C. and 29° C. (see line G, FIG. 7D). In response to the erroneous temperature variations readings by the control system, flow through the MFC was increased.

As stated above, an MFC may be constructed having a sintered element or an elongated (such as a capillary tube or other means known in the art) laminar flow element with a large pressure drop across the flow restrictor compared to the supply pressure may be positioned within the MFC 10. When a hard vacuum is applied to the flow restrictor outlet 52 a highly nonlinear flow characteristic of flow versus supply pressure is formed, thereby forming a pressure drop of approaching 100% when compared to the pressure at the flow restrictor inlet 50. As a result, the higher incremental pressure required per unit of flow increase reduces the effects of errors induced by zero drift error on the pressure transducer at low flows. For example, the effect of a 1 Torr zero shift on a transducer at the low end of the flow range may have only 1/20th or less of the effect it would have at the high end of the flow range. It may be desirable in certain industries, such as the semiconductor industry, to use an MFC that has more “Percent of Reading” calibration error characteristics. This may allow such benefits as inventory reduction, increased accuracy at lower pressure ranges, and flexibility.

Accordingly, a higher accuracy pressure based flow controller may be provided as described above. It is understood that the preceding description is illustrative only and that alternate designs may be used to achieve similar functionality, as will be readily apparent to those skilled in the art.

What is claimed is:

1. A method for controlling fluid flow, the method comprising:
providing a mass flow controller having a nonlinear flow restrictor configured to produce a highly compressible laminar flow therethrough;
identifying a target flow rate;
measuring the pressure downstream of the nonlinear flow restrictor;
obtaining a temperature measurement from at least one thermal sensor positioned within the mass flow controller;
determining the value of the pressure upstream that is needed to achieve the identified target flow rate; and
operating a flow valve positioned within the mass flow controller to assist in achieving the identified target flow rate.

2. A mass flow controller, comprising:
a body portion having a first internal passage and a second internal passage formed therein;
a flow control valve coupled to the body portion and in communication with the first and second internal passages;
at least one pressure transducer coupled to the body portion and in communication with at least one of the first and second internal passages;
a nonlinear flow restrictor coupled to the second internal passage, wherein the non-linear flow restrictor comprises an elongated path length and is configured to produce a highly compressible laminar flow therethrough;
a thermal sensor in communication with at least one of the first internal passage, the second internal passage, and the nonlinear flow restrictor; and
an exhaust vessel in communication with the nonlinear flow restrictor.

3. The device of claim 2 wherein the second internal passage is configured to flow a fluid at a pressure greater than a pressure at an output of the nonlinear flow restrictor.

4. The device of claim 2 wherein the exhaust vessel is under vacuum.

5. The device of claim 2 wherein the exhaust vessel is under near vacuum.

6. The device of claim 2 wherein the exhaust vessel is at about 0 psia to about 5 psia.

7. The device of claim 2 wherein the non-linear flow restrictor is manufactured from a compressed and sintered material.

8. The device of claim 2 wherein the non-linear flow restrictor is porous.

9. The device of claim 2 wherein the non-linear flow restrictor comprises a coiled capillary tube.

10. The device of claim 2 wherein the non-linear flow restrictor is positioned downstream of the flow control valve.

11. The device of claim 2 wherein the non-linear flow restrictor is configured to enable a pressure drop between a flow restrictor inlet and a flow restrictor outlet of a highly compressible laminar flow of at least 50 percent.

12. The device of claim 2 further comprising at least one pressure transducer in communication with an outlet of the non-linear flow restrictor.

13. A mass flow controller, comprising:
a flow control valve;
a pressure transducer positioned downstream of the flow control valve;
a nonlinear restrictor comprising an elongated path length with an inlet and an outlet, wherein the nonlinear restrictor is configured to produce a highly compressible laminar flow therethrough and wherein the nonlinear restrictor is positioned downstream of the pressure transducer; and
a thermal sensor in communication with the nonlinear flow restrictor.

14. The device of claim 13 wherein the nonlinear restrictor further comprises an internal diameter, and wherein the ratio of the elongated path to the internal diameter is large.

15. The device of claim 13 wherein the nonlinear restrictor is configured to provide a pressure drop between the inlet and the outlet of at least about 50%.

16. The device of claim 13 wherein the nonlinear restrictor comprises an elongated capillary body having a small hydraulic diameter.

17. The device of claim 13 wherein the nonlinear restrictor comprises a sintered body.

18. The device of claim 13 wherein the nonlinear restrictor comprises a porous body having pores formed in parallel and series thereon.

19. The device of claim 13 wherein the nonlinear restrictor is formed in a variety of configurations selected from the group consisting of capillary tubes, annular gaps, annular plates, parallel plates, grooved plates, stacked plates, coiled capillary bodies, and coiled sheets.

20. The device of claim 1 wherein the nonlinear restrictor is configured to enable a pressure drop between the inlet and the outlet of highly compressible laminar flow of at least 50 percent.
